(19) United States
(12) Patent Application Publication
(10) Pub. No.: US 2004/0258068 A1
(43) Pub. Date: Dec. 23, 2004

(54) Packet transmission method, process, and system

(76) Inventors: Lee Booi Lim, Butterworth (MY); Andrew Chih Howe Khor, Prai (MY); Boon Leong Ong, Kuala Kangsar (MY)

Correspondence Address: FISH & RICHARDSON, PC, 12390 EL CAMINO REAL, SAN DIEGO, CA, 92130-2081, US

(21) Appl. No.: 10/601,000

(22) Filed: Jun. 20, 2003

(51) Int. Cl. H04L 12/56

(52) U.S. Cl. 370/394; 370/392

(57) ABSTRACT

A process, method, and system that monitors data packets received by one or more network connections, and associates a maximum delay period with each network connection monitored. A transmission queue is maintained for each of the maximum delay periods associated with a network connection, such that each transmission queue includes queue entries that identify the data packets to be transmitted within the respective maximum delay period.

### BACKGROUND

Networks (e.g., local area networks, wide area networks, intranets, extranets, and the Internet) typically include a backbone that transmits a communication signal (e.g., optical, electrical, or wireless) from a source to signal converters positioned at various points along the network backbone. Such signal converters convert data signals to a form usable by electrical data signal processing circuitry.

On packet switched networks, data is transported across network backbones in data chunks known as data packets. Most packets have a destination address included in the packet's header. When these packets arrive at their destination, they are reassembled and provided to the destination device.

The signal processing circuitry that receives these data packets often has to retransmit these packets to a remote location (e.g., another switch, hub, or router). Additionally, different network-topologies often require the data packets to be transformed or converted prior to retransmission. For example, asynchronous transfer mode (ATM) networks transfer data using fixed-length fifty-three byte data packets, known as cells. To increase efficiency, multiple smaller data packets are often used fill a larger ATM cells.

### DESCRIPTION OF DRAWINGS

FIG. 1 is a block diagram of a network system incorporating a packet transmission process;

FIG. 2 is a block diagram of the packet transmission process;

FIG. 3 is another block diagram of a network system incorporating the packet transmission process; and

FIG. 4 is a flowchart of a packet transmission method.

### DETAILED DESCRIPTION

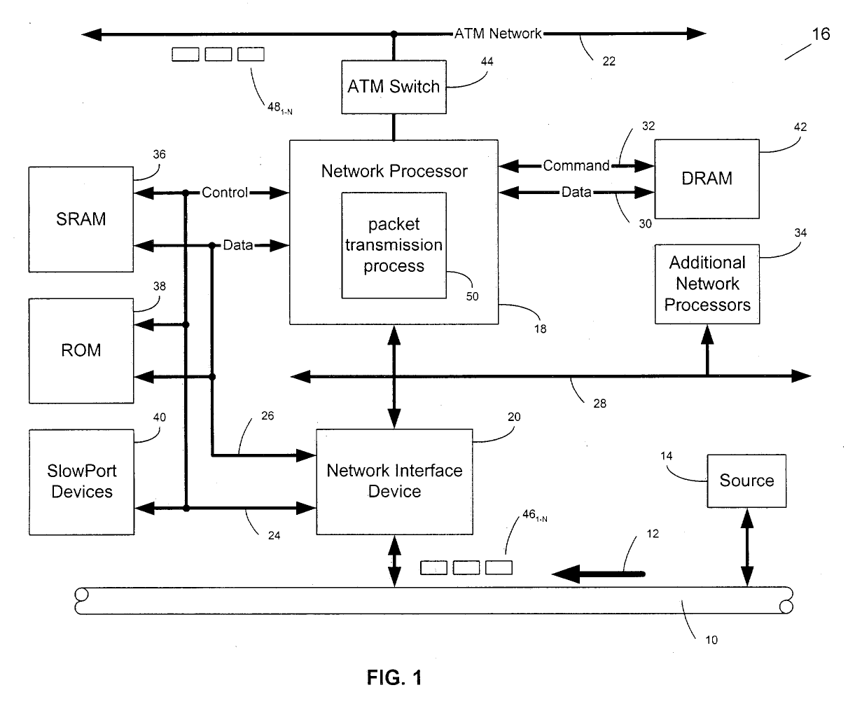

Referring to FIG. 1, a network 10 is used to transfer data 12 from a source 14 to a network signal processing system 16. Network 10 can use any medium (e.g. electrical, optical, and wireless) and be of any type (e.g., a local area network, a wide area network, an intranet, an extranet, the Internet, Ethernet, Arcnet, Token Ring, packet-switched, circuit-switched, and so forth). Source 14 and network signal processing system 16 may be incorporated into any device on a network, such as a printer, a personal computer, a router, a gateway, a network server, a network interface card, or a cable modem.

Network signal processing system 16 includes a network processor 18 for processing data 12 retrieved or transmitted by the network interface device 20. A typical example of network processor 18 is an Intel IXP1200 Network Processor, and network interface device 20 may be any media access control (MAC) addressable device. For example, the Intel IXP1200 Network Processor includes a pair of Reduced Instruction Set Computer (RISC) multithreaded packet engines that share resources, such as memory.

Network interface device 20 typically includes the required circuitry to convert data signal 12 from the format available on network 10 into a format useable by network processor 18. For example, if network 10 is an optical network, network interface device 20 is typically configured so that it can receive an optical signal and convert that optical signal to an electrical-based signal useable by network processor 18.

Network processor 18 typically interfaces with various other networks, and buses (e.g., network 22, and buses 24, 26, 28, 30, 32) to interconnect various devices and circuitry, such as additional network processors 34, static random access memory (SRAM) 36, read only memory (ROM) 38, SlowPort devices 40 (e.g flash memory, Universal Asynchronous Receiver/Transmitter (UART), and Universal Serial Bus (USB)), and dynamic random access memory (DRAM) 42.

In this particular embodiment, network 22 is an asynchronous transfer mode (ATM) network, and network processor 18 is interconnected with ATM network 22 via ATM switch 44.

In packet-switching networks (as opposed to circuit-switching networks), data 12 is transported in the form of packets 46_{1-N} of various sizes. As packets 46_{1-N} are received by network interface device 20, individual data packets are temporarily stored until these packets can be processed by network processor 18.

ATM network 22 transports data in the form of equal-length cells 48_{1-N}, which are typically fifty-three bytes long. Network processor 18 includes a packet transmission process 50 that incorporates (i.e. packs) the unequal-length data packets 46_{1-N} into one or more equal-length cells 48₁₋ₙ. Typically, packet transmission process 50 is stored on some form of non-volatile memory, such as ROM 38. However, other types of storage devices may be used.

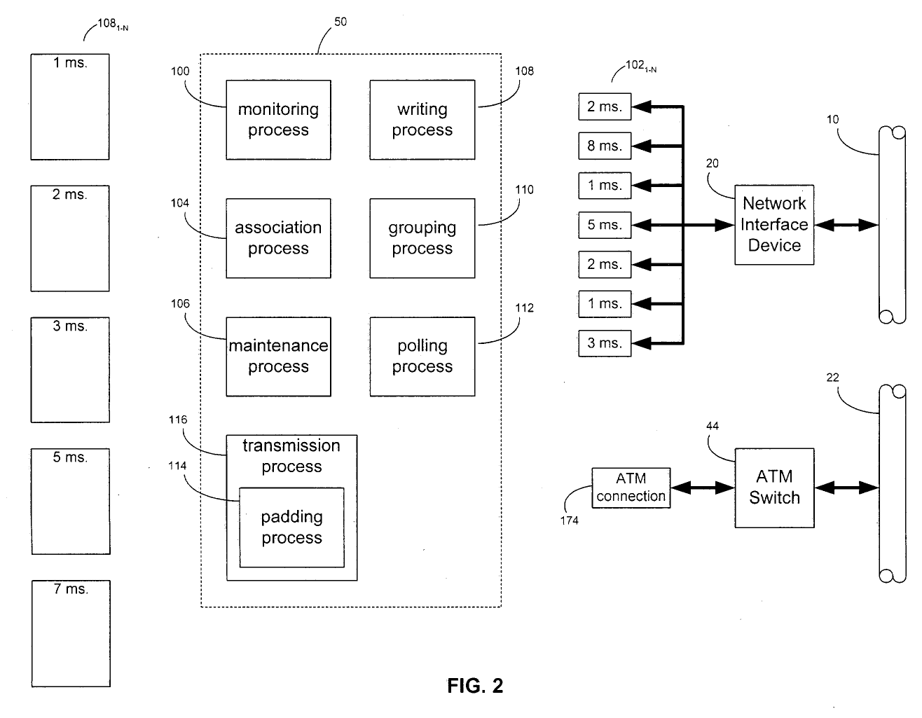

Referring to FIGS. 1 and 2, packet transmission process 50 includes a monitoring process 100. Monitoring process 100 monitors the data packets 46_{1-N} received by the network connections 102_{1-N} established with network 10 by network processor 18/network interface device 20. Examples of a network connection 102_{1-N} are: a permanent virtual circuit; a TCP/IP flow; and a permanent virtual path.

Each of these network connections 102_{1-N} typically transmits data (in the form of packets) from a sender to a receiver by using a series of “hops”. A hop occurs when a device, that is neither the original sender of the data nor the intended recipient of the data, receives the data and retransmits it. Thus, a “hop” occurs each time the data is relayed.

Additionally, whenever data is received from a first network and retransmitted onto a second network, a “hop” occurs. An example of this procedure is when a data packet is received from an Ethernet network and subsequently retransmitted onto an ATM network.

As computer networks operate as neural networks, there is no linear transmission path between a transmitter and receiver of data. Therefore, if a data signal is broken down into ten data packets, each of the ten data packets may arrive at the final destination via a unique transmission path.

Since the data transmitted needs to be properly reassembled by the recipient device, it is important that the data packets arrive at their final destination within a reasonable amount of time. Accordingly, each of the network connections 102_{1-N} monitored by monitoring process 100 has a maximum time delay period associated with it, which specifies the maximum amount of time that a data packet can be delayed prior to it being retransmitted. This maximum delay period specifies the maximum duration of a “hop”. The association of a maximum delay period with each of the network connections 102_{1-N} being monitored is handled by an association process 104. These maximum delay periods are usually defined when the network connections 102_{1-N} are established, and are usually specified in milliseconds (ms). Typical examples of these maximum delay periods include one, two, four, and eight milliseconds.

A maintenance process 106 maintains transmission queues 108_{1-N} that are related to each unique maximum delay period associated with a network connection 102_{1-N} For example, if there are ten network connections, five of which have a maximum delay period of one millisecond and five of which have a maximum delay period of two milliseconds, maintenance process 106 establishes and maintains two transmission queues, one associated with a one millisecond maximum delay period and one associated with a two millisecond maximum delay period. Each of these transmission queues 108_{1-N} is used to keep track of the individual data packets that should be transmitted within the maximum delay period associated with the queue. These transmission queues may be configured as first-in-first-out (FIFO) buffers, circular buffers, or tables.

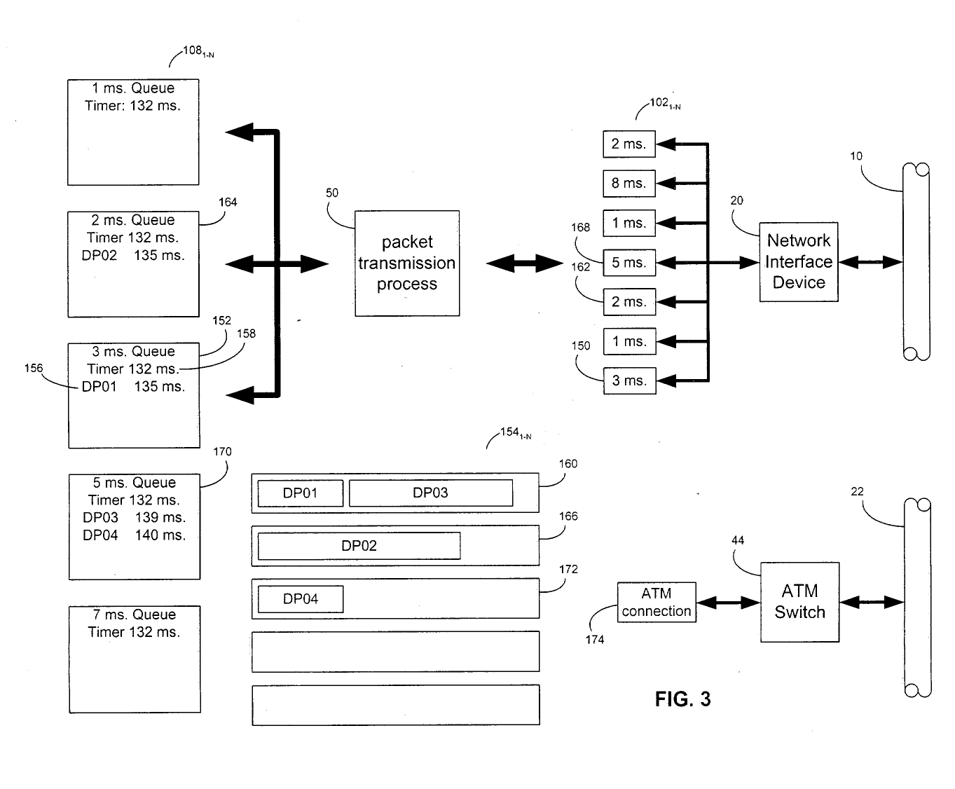

Referring to FIGS. 2 and 3, if data packet DP01 is received on network connection 150, which has a maximum delay period of three-millisecond (3 ms), as discussed above, that data packet should be retransmitted to either its intended recipient or another “hop” location within a 3 ms period. A writing process 108 places an entry into the three-millisecond transmission queue (i.e., queue 152) indicating that data packet DP01 should be retransmitted within 3 ms.

Data packet DP01 is retransmitted onto an ATM network 22 that transmits data using fixed-length cells. Accordingly, the individual variable-length data packets (e.g., data packet DP01) received by network interface device 20 are packed into fixed-length cells 154_{1-N} prior to be transmitted onto ATM network 22.

Whenever a variable length data packet is received that is larger than the fifty-three byte length of the fixed-length cell, that larger variable-length data packet is broken down into multiple fifty-three byte portions. For example, if a variable-length data packet is received that is one-hundred-seventy-nine bytes long, this data packet may be broken down into three fifty-three byte cells and one twenty byte cell. These actual numbers may vary due to header information included in either the data packet or the cell.

As the first three cells are full fifty-three byte cells, they can be immediately transmitted to their destination or a “hop” location. However, concerning the unfilled cell that only includes twenty bytes of information, while this cell may be padded (i.e., filled with zeros) and transmitted, this results in an inefficient transfer, since only approximately 38% of the cell's capacity is being used. Accordingly, it is desirable to group multiple smaller data packets within a single cell prior to that cell being transmitted. However, any delay associated with grouping data packets within a single cell cannot exceed the maximum delay period associated with any data packet grouped within the cell.

Continuing with the above-stated example, if data packet DP01 received on network connection 150 has a length of twenty bytes, packet transmission process 50 will attempt to group data packet DP01 with other packets to better fill the cell within which data packet DP01 is being transmitted.

As discussed above, an entry 156 will be made by writing process 108 into transmission queue 152 (i.e., the queue associated with a 3 ms maximum delay period). Typically, entry 156 includes an identifier for the data packet to be transferred and the deadline for transmission. In this case., the deadline is listed as “135 ms”. The listed value specifies the deadline with respect to a timer 158 associated with the queue 152. Each of the transmission queues 108_{1-N} has a timer that is continuously incremented. Whenever an entry is made into one of the transmission queues 108_{1-N}, the transmission deadline associated with the entry is the value of the timer 158 plus the maximum delay period associated with that particular queue. Accordingly, the deadline of 135 ms was determined by summing the value of the timer (i.e., 132 ms) and the maximum delay associated with the queue (i.e., 3 ms).

Concerning data packet DP01, in addition to an entry being placed into the appropriate queue that identifies the data packet, the actual data packet is placed into a cell for future transmission. Packet transmission process 50 includes a grouping process 110 for placing data packets into cells for future transmission. In this particular example, grouping process 110 places data packet DP01 into cell 160. As cell 160 is a fifty-three byte cell and data packet DP01 is only twenty bytes long, there are thirty-three bytes of unused storage available in cell 160. As additional data packets are received, grouping process 110 examines the size of the packets to determine if the additional data packets can be grouped with other packets in partially filled cells.

For example, if the next data packet received (i.e., DP02) is forty bytes long and has a 2 ms maximum delay period (i.e., it was received on network connection 162), writing process 108 places an entry into queue 164 (i.e., the two millisecond queue). If this data packet was received 1 ms after DP01, the timer for queue 164 would be at 133 ms and, therefore, the transmission deadline entered into queue 164 is 135 ms.

While grouping process 110 attempts to arrange multiple data packets together within a single cell, as data packet DP02 is forty bytes long and cell 160 only has thirty-three bytes of free space, grouping process 110 places data packet DP02 into cell 166.

Packet transmission process 50 includes a polling process 112 for periodically polling the transmission queues to determine which data packets need to be transmitted. The frequency of this polling should be set so that it ensures the timely transmission of data packets. For example, if the timer(s) used within the various queues are incremented in 0.01 ms increments, polling process 112 would probably be configured so that the queues are polled at least every 0.01 ms, so as to avoid missing any transmission deadlines.

When polling occurs, polling process 112 compares the current value of the timer to the various transmission deadlines within the queues to determine if any of the data packets need to be transmitted. Since the current value of the timer is 133 ms and the earliest deadline in the queues is 135 ms (for both DP01 and DP02), neither cell 160 nor cell 166 needs to be transmitted yet.

Continuing with the above-stated example, a third packet DP03 having a length of thirty bytes is received on network connection 168 when the queue timer (i.e., queue timer 158) is 134 ms (i.e., 1 ms after DP02 was received and 2 ms after DP01 was received). As network connection 168 is a 5 ms connection, writing process 108 writes a queue entry into queue 170 (i.e., the 5 ms queue) which defines the transmission deadline as 139 ms (i.e., 134 ms plus 5 ms). Since cell 160 has thirty-thee bytes of available space and data packet DP03 is thirty bytes long, grouping process 110 places data packet DP03 into cell 160, resulting in 94% utilization of cell 160.

Assuming that polling process 112 again polls the queues to determine if any transmission deadlines are due, since the time value is currently 134 ms and the earliest transmission deadline is still 135 ms, no cells need to be transmitted.

If one millisecond later (i.e., a timer value of 135 ms), a fourth data packet DP04 having a length of twenty bytes is received on network connect 168 (i.e., the 5 ms network connection), writing process 108 writes an entry into queue 170 that defines the transmission deadline for data packet DP04 as 140 ms. Since data packet DP04 is twenty bytes long, cell 160 has only three bytes of free space and cell 166 has only thirteen bytes of free space, data packet DP04 is written to an empty cell 172.

Assuming that polling process 122 again polls the queues to determine if any transmission deadlines are due, since the time value is currently 135 ms, two data packets (i.e. DP01 and DP02) need to be transmitted. Since DP01 is in cell 160 and DP02 is in cell 166, both cells need to be transmitted.

As stated above, cell 160 includes two data packets DP01 and DP03, such that the sum of these data packets is fifty bytes. Since cell 160 needs to be immediately transmitted, a padding process 114 fills in the remaining three bytes with zeros prior to transmitting the cell. As cell 166 is also not completely filled, that cell is also filled (i.e., padded) by padding process 114.

Once cell 160 and 166 are filled, transmission process 116 transmits these cells (via ATM connection 174, ATM switch 44, and ATM network 22) to their intended destination (i.e., the intended recipient or another “hop” location) While the timer associated with an individual queue is described above as being an incrementing counter, other configurations are possible, such as a decrementing counter. However, this would require that the maximum delay period be subtracted from the value of the timer at the time of entry.

While the individual data packets placed into a common ATM cell are described above as potentially being from different transmission queues, preferably all of these data packets are from a common transmission queue and, therefore, all have a common maximum delay period.

While the entries of the individual queues are described above as only including an identifier for the data packet and the deadline associated with transmitting that data packet, additional information may be required, such as information that locates the packet within memory and/or information that specifies the cell into which the data packet is packed.

While the grouping process 110 is described above as arranging multiple data packets (in their entirety) within a single cell, other configurations are possible. For example, if data packet DP02 is forty bytes long and cell 160 has only thirty-three bytes of free space, grouping process 110 may place the first thirty-three bytes of data packet DP02 into cell 160, and the remaining seven bytes of data packet DP02 into cell 166.

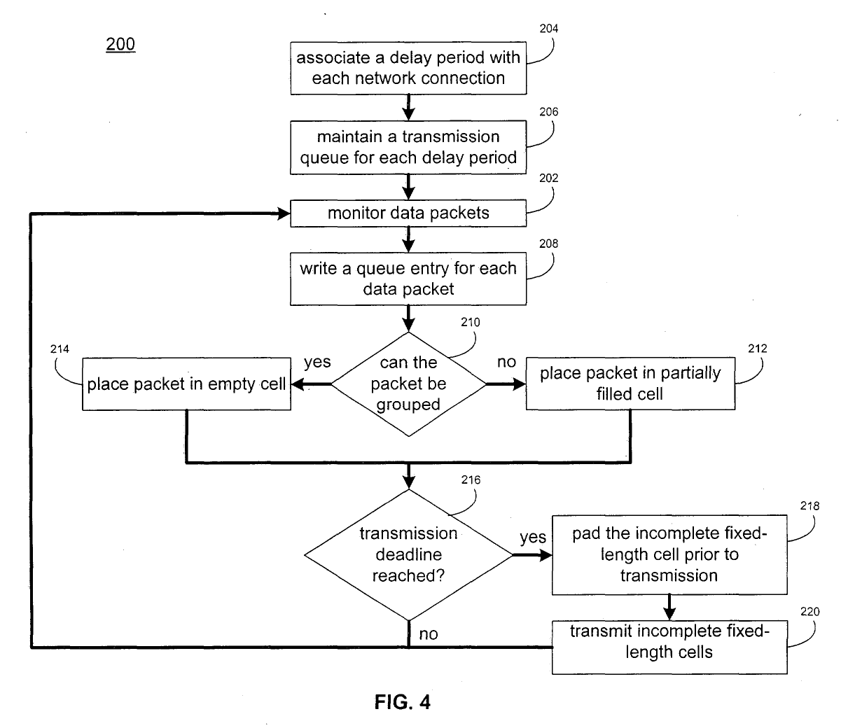

Referring to FIG. 4, a method 200 includes monitoring 202 data packets received by one or more network connections, and associating 204 a maximum delay period with each network connection being monitored. A transmission queue is maintained 206 for each of the maximum delay periods associated with a network connection, such that each of the transmission queues identifies the data packets to be transmitted within the respective maximum delay period. Whenever a data packet is received on a network connection, an entry is written 208 into the transmission queue that corresponds with the maximum delay period associated with the network connection from which the packet was received. Further, upon receipt of a data packet, the partially filled cells are examined 210 to determine if the data packet can be grouped with the data packets within an existing cell. If so, the data packet is placed 212 into a partially filled cell. If not, the data packet is placed 214 into an empty cell.

The transmission queues are periodically polled 216 to determine it any data packet's transmission deadline has been reached. If so, the cell into which the data packet is placed is padded 218 and the cell is transmitted 220 to its destination. If not, the data packet monitoring 202 continues monitoring data packets.

The described system is not limited to the implementations described above; it may find applicability in any computing or processing environment. The system may be implemented in hardware, software, or a combination of the two. For example, the system may be implemented using circuitry, such as one or more of programmable logic (e.g., an ASIC), logic gates, a processor, and a memory.

The system may be implemented in computer programs executing on programmable computers, each of which includes a processor and a storage medium readable by the processor (including volatile and non-volatile memory and/or storage elements). Each such program may be implemented in a high-level procedural or object-oriented programming language to communicate with a computer system. However, the programs can be implemented in assembly or machine language. The language may be a compiled language or an interpreted language.

Each computer program may be stored on an article of manufacture, such as a storage medium (e.g., CD-ROM, hard disk, or magnetic diskette) or device (e.g., computer peripheral), that is readable by a general or special purpose programmable computer for configuring and operating the computer when the storage medium or device is read by the computer to perform the functions of the data framer interface. The system may also be implemented as a machine-readable storage medium, configured with a computer program, where, upon execution, instructions in the computer program cause a machine to operate to perform the functions of the system described above.

Implementations of the system may be used in a variety of applications. Although the system is not limited in this respect, the system may be implemented with memory devices in microcontrollers, general purpose microprocessors, digital signal processors (DSPs), reduced instruction-set computing (RISC), and complex instruction-set computing (CISC), among other electronic components.

Implementations of the system may also use integrated circuit blocks referred to as main memory, cache memory, or other types of memory that store electronic instructions to be executed by a microprocessor or store data that may be used in arithmetic operations.

A number of implementations have been described. Nevertheless, it will be understood that various modifications may be made. Accordingly, other implementations are within the scope of the following claims.

What is claimed is:

1. A method comprising:
monitoring data packets received by one or more network connections;
associating one of a plurality of maximum delay periods to each network connection being monitored; and
maintaining a transmission queue for each of the maximum delay periods associated with a network connection, wherein each transmission queue includes one or more queue entries that identify the data packets to be transmitted within the respective maximum delay period.

2. The method of claim 1 wherein the maximum delay period defines the maximum delay between the receipt of a data packet and the transmission of at least a portion of the data packet.

3. The method of claim 2 further comprising:
concatenating at least portions of two or more data packets into a fixed-length cell.

4. The method of claim 3 wherein the fixed-length cell is an asynchronous transfer mode (ATM) cell that is fifty-three bytes long.

5. The method of claim 3 wherein each of the maximum delay periods defines a transmission deadline for transmitting a data packet, the method further comprising:
transmitting incomplete fixed-length cells that are not completed prior to an earliest one of the transmission deadlines of the data packets concatenated into the fixed-length cell.

6. The method of claim 5 wherein transmitting incomplete fixed-length cells includes padding the incomplete fixed-length cell with placeholder information prior to transmitting the incomplete fixed length cell.

7. The method of claim 1 further comprising:
writing a queue entry to the transmission queue maintained for a specific maximum delay period in response to a data packet being received on a network connection that is associated with the specific maximum delay period.

8. The method of claim 7 further comprising:
polling the transmission queue to determine which data packets should be transmitted.

9. The method of claim 7 wherein the queue entry identifies the data packet received and the maximum delay period.

10. The method of claim 9 wherein the maximum delay period defines a transmission deadline.

11. The method of claim 1 wherein the network connection is a permanent virtual circuit.

12. A computer program product residing on a computer readable medium having a plurality of instructions stored thereon which, when executed by the processor, cause that processor to:
monitor data packets received by one or more network connections;
associate one of a plurality of maximum delay periods to each network connection being monitored; and
maintain a transmission queue for each of the maximum delay periods associated with a network connection, wherein each transmission queue includes one or more queue entries that identify the data packets to be transmitted within the respective maximum delay period.

13. The computer program product of claim 12 wherein the maximum delay period defines the maximum delay between the receipt of a data packet and the transmission of the same data packet.

14. The computer program product of claim 13 further comprising instruction to:
concatenate at least portions of two or more data packets into a fixed-length cell.

15. The computer program product of claim 14 wherein the fixed-length cell is an asynchronous transfer mode (ATM) cell that is fifty-three bytes long.

16. The computer program product of claim 14 wherein each of the maximum delay periods defines a transmission deadline for transmitting a data packet, the computer program product further comprising instructions to:
transmit incomplete fixed-length cells that are not completed prior to an earliest one of the transmission deadlines of the data packets concatenated into the fixed-length cell.

17. The computer program product of claim 16 wherein the instructions to transmit incomplete fixed-length cells includes instructions to pad the incomplete fixed-length cell with placeholder information prior to transmitting the incomplete fixed length cell.

18. The computer program product of claim 12 further comprising instructions to:
write a queue entry to the transmission queue maintained for a specific maximum delay period whenever a data packet is received on a network connection that is associated with the specific maximum delay period.

19. The computer program product of claim 18 further comprising instructions to:
poll the transmission queue to determine which data packets need to be transmitted.

20. The computer program product of claim 18 wherein the queue entry identifies the data packet received and the maximum delay period.

21. The computer program product of claim 20 wherein the maximum delay period defines a transmission deadline.

22. The computer program product of claim 12 wherein the network connection is a permanent virtual circuit.

23. An asynchronous transfer mode (ATM) switch comprising:
a media access control (MAC) addressable device including a processor configured to:
monitor the data packets received by the one or more network connections;
associate one of a plurality of maximum delay periods to each network connection being monitored; and
maintain a transmission queue for each of the maximum delay periods associated with a network connection, wherein each transmission queue includes one or more queue entries that identify the data packets to be transmitted within the respective maximum delay period.

24. The system of claim 23 wherein the maximum delay period defines the maximum delay between the receipt of a data packet and the transmission of the same data packet.

25. The system of claim 24 wherein the processor is further configured to:
concatenate at least portions of two or more data packets into a fixed-length cell.

26. The system of claim 25 wherein the fixed-length cell is an asynchronous transfer mode (ATM) cell that is fifty-three bytes long.

27. The system of claim 25 wherein each of the maximum delay periods defines a transmission deadline for transmitting a data packet, wherein the processor is further configured to:
transmit incomplete fixed-length cells that are not completed prior to an earliest one of the transmission deadlines of the data packets concatenated into the fixed-length cell.

28. The system of claim 27 wherein the processor is further configured to:
pad the incomplete fixed-length cell with placeholder information prior to transmitting the incomplete fixed length cell.

29. The system of claim 23 wherein the processor is further configured to:
write a queue entry to the transmission queue maintained for a specific maximum delay period whenever a data packet is received on a network connection that is associated with the specific maximum delay period.

30. The system of claim 29 wherein the processor is further configured to:
poll the transmission queue to determine which data packets need to be transmitted.

31. The system of claim 29 wherein the queue entry identifies the data packet received and the maximum delay period.

32. The system of claim 31 wherein the maximum delay period defines a transmission deadline.

33. The system of claim 23 wherein the processor is a network processor including a set of multithreaded packet engines.
